(19) United States
(12) Patent Application Publication
(10) Pub. No.: US 2002/0131651 A1
(43) Pub. Date: Sep. 19, 2002

(54) System and method for reducing images including graphs

(76) Inventors: Chandrashekhara Anantharamu, Singapore (SG); Srikumar Karaikudi Subramanian, Singapore (SG); Vinod Vasudevan, Singapore (SG)

Correspondence Address: MORRISON & FOERSTER LLP, 2000 PENNSYLVANIA AVE, NW, SUITE 5500, WASHINGTON, DC, 20006-1888, US

(21) Appl. No.: 09/758,230

(22) Filed: Jan. 12, 2001

(51) Int. Cl. G06K 9/36

(52) U.S. Cl. 382/284; 382/298

(57) ABSTRACT

This invention provides a system and method to reduce rectangular graph images. According to the invention, the main graph and axis portions of a rectangular graph image are reduced separately such that readability and clarity of the entire graph image is maintained. The axes of the graph are reduced according to a position of the text values included on the axes of the image. The system may be accessed over a network by display devices when reducing for display images that include rectangular graphs.

### FIELD OF THE INVENTION

This invention relates generally to systems and methods for transcoding of images and, more specifically, to adaptive transcoding of images including graphs or charts.

### BACKGROUND OF THE INVENTION

There are many techniques that may be used to reduce an image for display on display devices of varying sizes. Many conventional image reduction techniques reduce an entire image proportionately so that the relative size of the image display remains the same. These techniques work well for many images. However, such reduction techniques may not be appropriate for images that include graphs or charts. Reducing a complete image uniformly reduces the clarity of the entire image without regard to the underlying structure of the image. Generally, that is acceptable for pictorial images. However, reduced textual images require a different clarity to maintain their readability. Too significant a reduction of text decreases its readability. Therefore, a reduction process that is appropriate for a pictorial image may not be appropriate for a textual image. Graph images include both pictorial image and textual images. To maintain the clarity and readability of an entire graph image, the pictorial and textual image components may therefore need to be processed according to different reduction techniques.

FIG. 1A depicts an original graph image. FIG. 1B depicts a reduced graph image that has been reduced according to the bicubic, bilinear, and nearest neighbor prior art techniques, respectively. Each of these techniques uses a different method to reduce the graph, but none reduces the image and maintains the readability and clarity of the textual information included in the image.

Another shortcoming of conventional methods for reducing images is that they are generally device-specific and can only be used to reduce images that will be displayed on devices that have certain capabilities or characteristics. For example, not all devices have the same color capabilities. Conventional methods of image reduction generally require that a different reduction technique be used to reduce an image according to the color capabilities of a particular device.

Despite the lack of adequate reduction techniques, an increasing number of handheld, limited capability devices are being used to view a variety of information including graph images. For example, stock values may be provided via the web in a bar graph format and viewed by a consumer on a handheld, limited capability PDA (personal digital assistant) device. Conventional methods for reducing images are not effective in reducing graphs and charts for display on such limited-capability handheld devices.

Accordingly, a need exists for a non-device specific manner to reduce graph images for display on limited capability handheld devices.

### SUMMARY OF THE INVENTION

This invention provides a system and method to reduce rectangular graph images for display on limited capability handheld display devices.

In accordance with an embodiment of the present invention, a method for reducing a rectangular graph image is provided. The method includes identifying a main graph region and axes regions of an original graph image, correlating text values included in the axes regions to relative axes locations of the main graph image, prioritizing the text values, determining a number of the text values that can be displayed in a reduced-size graph image on a display device of a particular size, selecting the text values that will be displayed according to the prioritization of the text values, reducing the main graph region according to a first reduction process to create a reduced main graph region, reducing the axes regions according to a second reduction process to create reduced axes regions, and stitching together the reduced main graph region and the reduced axes regions according to the created correlation.

In accordance with another embodiment of the invention, a method for reducing a rectangular graph image for display on a limited-capability display device is provided. The method includes receiving an original rectangular graph image, determining the structure of the original rectangular graph image and dividing the original rectangular graph image into a main graph region and axes regions, receiving parameters reflecting display characteristics of the limited-capability display device, reducing the axes regions of the original rectangular graph region according to the characteristics of the display device and a location of values included in the axes regions, stitching together a reduced main graph region and the reduced regions to create a reduced graph image, and coding the reduced graph image to a format that is compatible with the display device.

In accordance with another embodiment of this invention a method is provided to reduce a rectangular graph image. The method includes receiving an original rectangular graph image, determining a structure of the original rectangular graph image and dividing the original rectangular graph image into a main graph region and axes regions, reducing the axes regions of the original rectangular graph image according to the structure of the original rectangular graph image and a characteristic of a display device, receiving a reduced main graph region, and stitching together the reduced main graph region and the reduced axes regions to create a reduced rectangular graph image.

In accordance with yet another embodiment of this invention, a method for reducing a rectangular graph image for display on a limited-capability display device is provided. The method includes receiving an original rectangular graph image, determining the structure of the original rectangular graph image and dividing the original rectangular graph image into a main graph region and axes regions, providing information reflecting display characteristics of the display device, reducing the axes regions of the original rectangular graph image according to a first reduction process that considers parameters of the display device and a location of values included in the axes regions, receiving a reduced main graph region that has been reduced according to a second reduction process, and stitching together a reduced main graph region and the reduced axes regions to create a reduced rectangular graph image.

In accordance with another embodiment of this invention, a system to reduce a rectangular graph image is provided. The system includes an adaptive graph image transcoder that receives an original rectangular graph image, decodes the original rectangular graph image, receives information reflecting a size and a color depth of the display device, and reduces axes regions of the original rectangular graph image according to one or more device parameters of the display device and a location of values included on the axes of the original rectangular graph image, and stitches together the reduced axes regions to a reduced main graph region, and a graph reduction device that reduces a main graph region of the original rectangular graph image according to the size of the display device.

In accordance with still another embodiment of this invention, a system to reduce a rectangular graph image for display on a display device is provided. The system includes an adaptive graph image transcoder that receives an original rectangular graph image including a main graph region and axes regions, receives one or more device parameters of the display device and a location of values included on axes of the original rectangular graph image, and reduces the axes regions of the original rectangular graph image according to a first reduction process that reduces the axes according to the parameters of the display device and the location of values included on the axes of the original rectangular graph image to create reduced axes regions.

In accordance with yet another embodiment of this invention, a computer-readable medium comprises instructions for reducing an original rectangular graph image. The instructions include identifying a main graph region and axes regions of an original graph image, correlating text values included in the axes regions to relative axes locations of the main graph image, prioritizing the text values determining a number of the text values that can be displayed in a reduced-size graph image on a display device of a particular size, selecting the text values that will be displayed according to the prioritization of the text values, reducing the main graph region according to a first reduction process to create a reduced main graph region, reducing the axes regions according to a second reduction process to create reduced axes regions, and stitching together the reduced main graph region and the reduced axes regions according to the created correlation.

In accordance with still another embodiment of this invention, a computer-readable medium comprises instructions for reducing an original rectangular graph image. More specifically, the instructions include receiving an original rectangular graph image, determining a structure of the original rectangular graph image and dividing the original rectangular graph image into a main graph region and axes regions, reducing the axes regions of the original rectangular graph image according to the structure of the original rectangular graph image and a characteristic of a display device, receiving a reduced main graph region, and stitching together the reduced main graph region and the reduced axes regions to create a reduced rectangular graph image.

### BRIEF DESCRIPTION OF THE DRAWINGS

FIG. 1A depicts an original graph image.

FIG. 1B depicts a reduced graph image that has been reduced according to the bicubic, bilinear, and nearest neighbor prior art techniques, respectively.

FIG. 2 depicts an overview block diagram of the invention.

FIG. 3 depicts the processing performed to reduce an image including a rectangular graph.

FIGS. 4A-4D depict the output of the stitching processing relative to reducing the graph image of FIG. 1A to various sizes.

### DETAILED DESCRIPTION OF THE INVENTION

This invention provides a non-device specific system and method to reduce images that include rectangular graphs while maintaining the readability and clarity of the information included in the graph. The term “rectangular graph” refers to a graph or chart that is bound by two axes, a horizontal axis and a vertical axis, each of which include values. Rectangular graphs have an origin which may be located at, for example, the bottom left corner, top right comer, bottom right corner, or top left corner of an image. Rectangular graphs include, for example, bar graphs, bar charts, and plotted line graphs. The image reduction system and method of the invention (referred to in the following description as an “adaptive graph image transcoder”) adapts to the capabilities of a display device that displays the reduced image including a rectangular graph, therefore making it effective for reducing rectangular graphs for display on a variety of limited capability devices of different sizes. As used herein, the term “transcode” refers to transforming and encoding, i.e., reducing and coding, an image.

This invention reduces an image that includes a rectangular graph according to the structure of the graph and therefore reduces the component parts of the graph such that the clarity and readability of all parts of the graph is maintained. The system is automatically activated when a client device accessing information, for example, a handheld device accessing information over the Internet, requests for display an image that includes a rectangular graph. The browser of the display device provides the system of the invention with various information about the display device including, for example, name of the browser, which, in turn, can be used to obtain parameters indicating a size of the display screen and a color depth of the device. For example, the system may store information correlating browser names with size and color depth information. The system reduces the graph image according to such characteristics and displays the reduced image on the display device. Therefore, the operation of this system is transparent to the user of the display device that displays a reduced image.

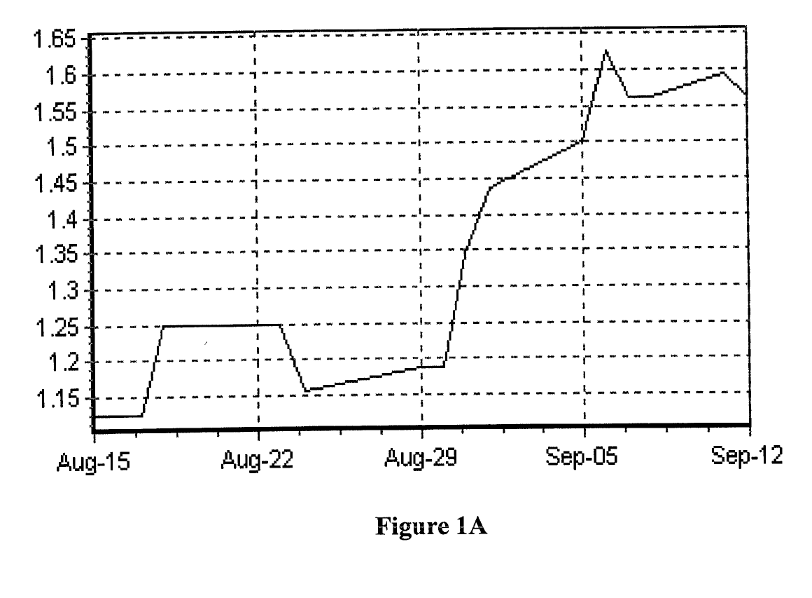

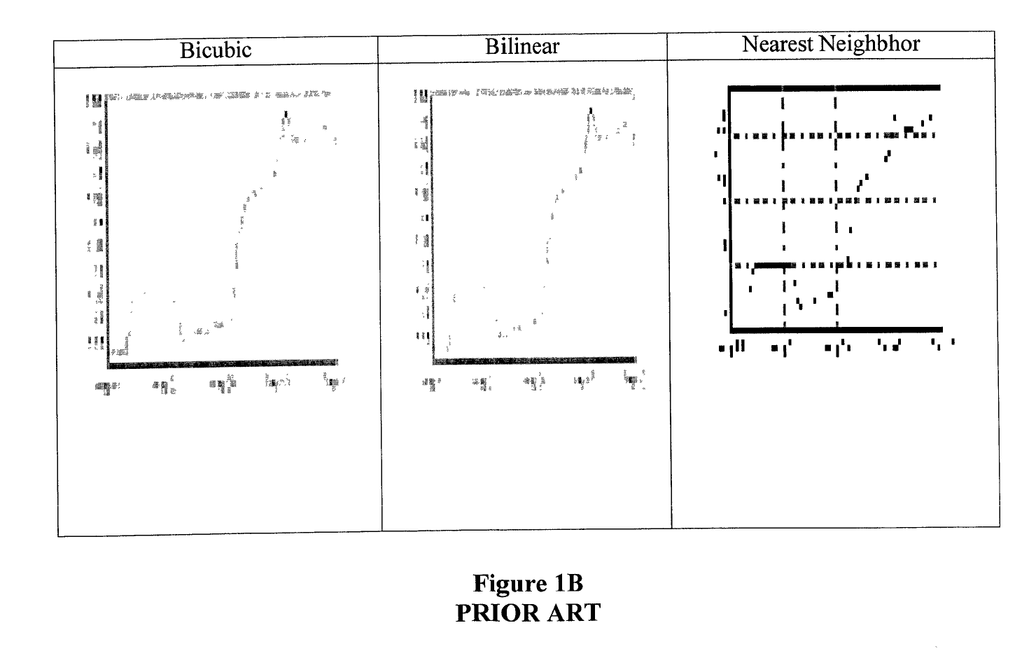

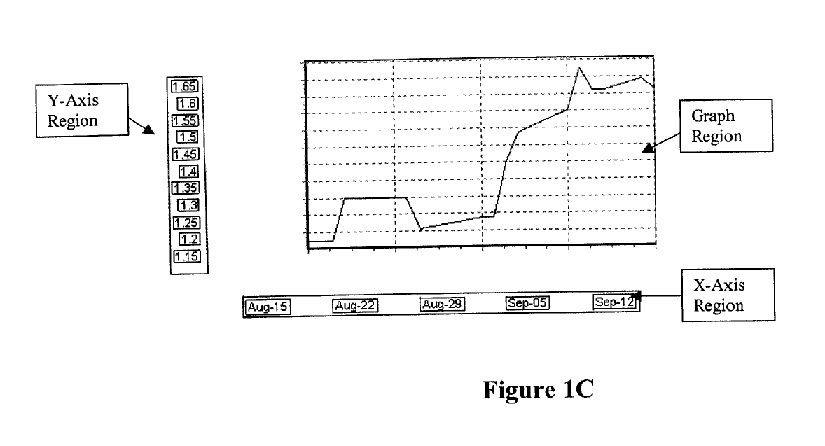

When reducing a rectangular graph image, the invention first confirms that an input image is a rectangular graph by determining a structure of the image. The structure of rectangular graph images is reflected by the position of the axes, the origin, and the main body of the graph. The invention determines the position of the axes according to the location of the origin and then divides the graph into components by segmenting the main body and text values of the axis regions. For example, a rectangular graph is divided into an x-axis region, a y-axis region, and a main graph region. FIG. 1C depicts the rectangular bar graph of FIG. 1A divided into the three component parts described above. Once the graph has been segmented, a frequency distribution of the color, shape and location of the body and axis regions is computed. This distribution is used to determine a color scheme of the original graph image such that the original graph image can be converted into a color scheme that is supported by the display device, described further below. Then, the main graph region and the axes regions are reduced separately and according to a size and a color depth of the display device and are “stitched” together to form a reduced image. The reduced image is coded into a specific device display format by a conventional coder. Further details of this process are provided below.

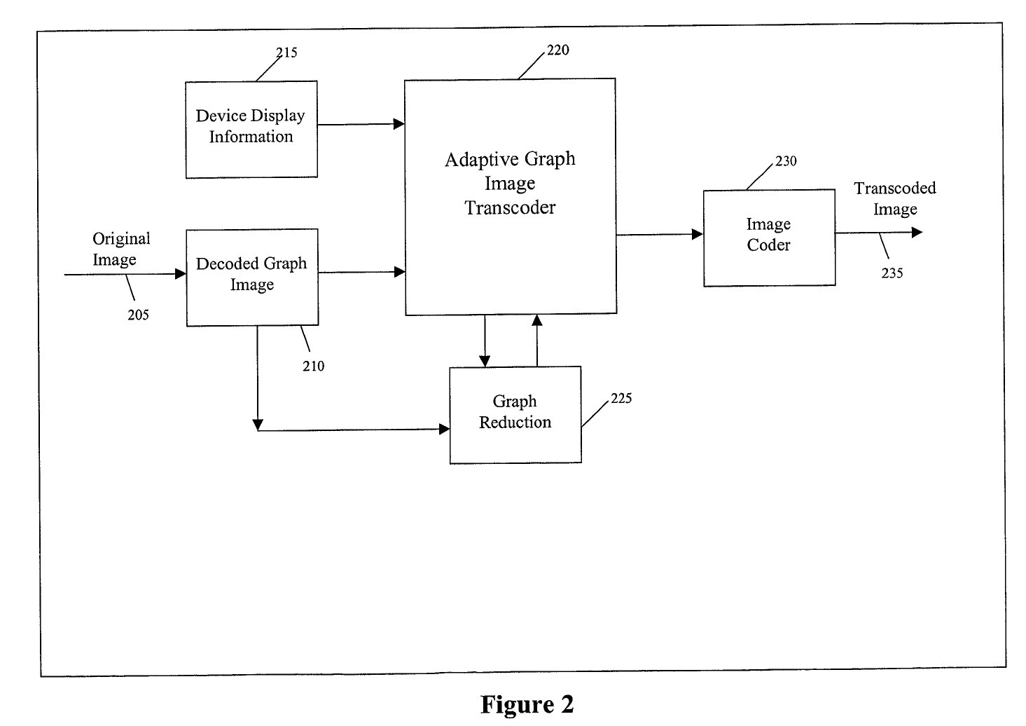

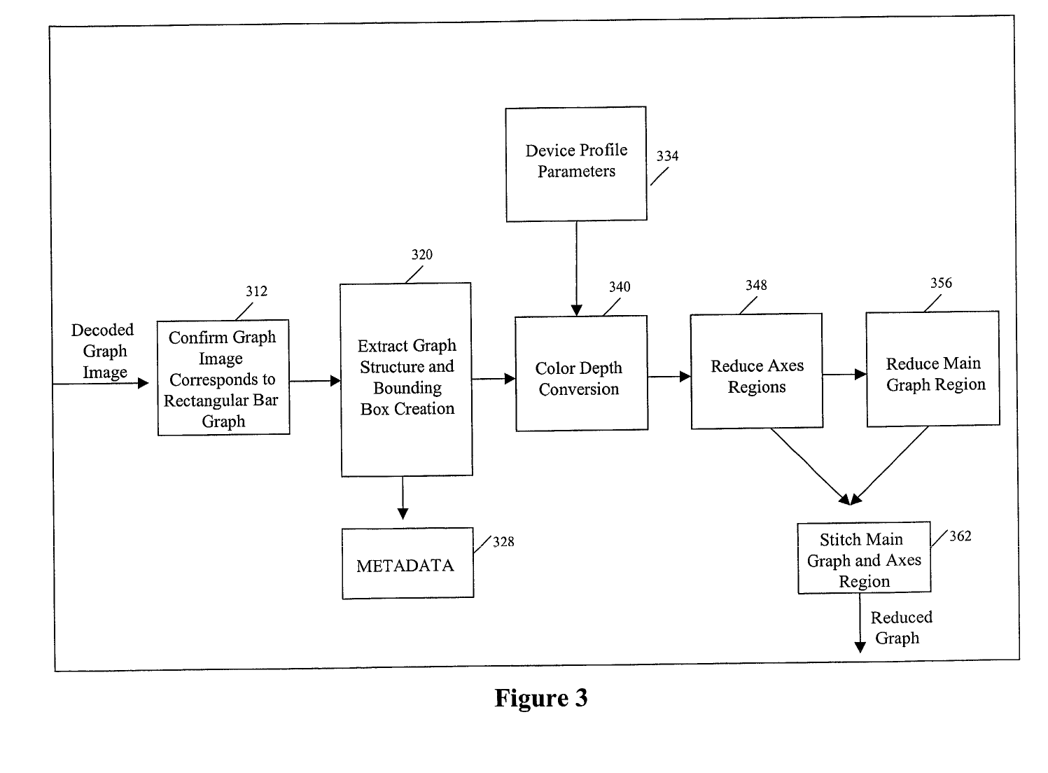

FIG. 2 depicts an overview block diagram of the invention. As depicted in FIG. 2, an input image (205), which is received in a compressed image format, e.g., JPEG, GIF, etc., is decompressed into a raw graph image (210). The system also receives from an Internet browser information reflecting the display device's browser type (215). Because the display devices use the Internet to access a graph image to be reduced, each display device includes a conventional Internet browser. The Internet browser transmits device or browser information to adaptive graph image transcoder 220. The decompressed graph image and information about the display device are input into the adaptive graph image transcoder 220. The adaptive graph image transcoder 220 separates the graph image into two regions, an axes region and a main graph region, which are processed separately. The axes and main graph regions are described further below, relative to FIG. 3. For the axes regions, location information indicating a relative position of an axis and text values associated with the axis are determined and stored by the system. This information is referred to as “metadata.” Further details of the metadata are provided below, relative to FIG. 3. The adaptive graph image transcoder 220 maintains a table of device capabilities and display characteristics for a variety of device browsers such that the received browser information can be processed and the original graph image reduced according to the device and/or browser capabilities and display characteristics. For example, the table includes information reflecting a width, height, and color depth of a display device. Thus, a device type can be identified by comparing the stored information with information received from a device's browser reflecting characteristics of various devices.

The adaptive graph image transcoder 220 reduces the axes region of the image. A conventional graph reduction system reduces the main graph region of the graph image (225). The adaptive graph image transcoder 220 outputs to an image coder a reduced, unformatted graph image, including the graph and axes regions, and the corresponding metadata including the analyzed features (230). Thus, the output of the adaptive graph image transcoder 220 is a non-device specific, uncompressed raw graph image and associated analysis information. The image coder compresses the reduced graph image into a specific format, e.g., JPEG, GIF, BMP, etc., that can be displayed by the display device (235).

FIG. 3 depicts the processing performed to reduce an image including a rectangular graph. First, an original graph image, which has been decompressed, i.e., decoded, into a raw graph image of RGB (red/green/blue) data is received by the system. Then, the system determines whether the received image includes a rectangular graph (312). The processing performed relative to 312 includes (1) converting the raw RGB image data to a gray scale image using, for example, a color conversion technique; and (2) defining horizontal and vertical projections of the graph image. The following color conversion technique uses bit dropping and forms an 8-bit value as 3R+3G+2B values, where 3R refers to the three most significant bits of a red value, 3G refers to the three most significant bits of a green value, and 2B refers to the two most significant bits of a blue value. For example, consider the following 8-bit RGB value:

| | | |
|---|---|---|
| R: 10100000 | Hex: A0 | Decimal: 160 |
| G: 11000000 | Hex: C0 | Decimal: 192 |
| B: 11100001 | Hex: E1 | Decimal: 225 |

By combining the three most significant bits of the red and green values and the two most significant bits of the blue values, the corresponding 8-bit gray value is 10111011, where “101 ” corresponds to the three most significant bits of the red value, “110” corresponds to the three most significant bits of the green value and “11 ” corresponds to the two most significant bits of the blue value. The corresponding hexadecimal value is BB; and the corresponding decimal value is 187. This conversion is performed for the complete original image and maintained as gray scale image data. One of skill in the art will appreciate that while a specific color conversion method has been described here, other color conversion methods may be used and remain within the scope of this invention.

Then the gray scale image is converted into a binary image by converting the gray scale image into binary bitmap values, with brighter gray values turned to “1” and the rest to “0.” For example, a threshold value of gray level 127 may be chosen to binarize the image. If so, all gray values which are greater than 127 are set to “1” and the rest are set to “0.”

Next, the structure of the graph is extracted from the graph image and smoothing is performed to create two-dimensional bounding boxes around each of the values included on the x and y axes of the graph image (320). The binary image data is then used to compute the horizontal and vertical projections of the image, which indicate how the graph is aligned and where the axis values reside. More specifically, this process correlates text in the axes regions to its relative axis location in the main graph image.

To compute the horizontal and vertical projections, the system determines how many black pixels are included in each row and column, respectively, of the graph image and then searches for peaks in the projection values. A peak refers to a row or column of the graph image that includes a maximum number of black pixels. A peak thus indicates the presence of a horizontal or vertical line, which can be an x-axis or a y-axis. The projection count increases significantly at a point where the x and y-axis lines intersect. According to the peaks of the graph image, the system segments the main graph region and axes regions, and determines the orientation of the graph image. See FIG. 1C. By determining where the x and y axes intersect, the relative positioning of the x and y axes, e.g., whether the x-axis is at the top or bottom of graph image and whether the y-axis is to the left or the right of the main graph image, can be determined. Thus, once the main graph region is determined, the region above or below the graph region is assigned as the x-axis region and the region to either side of the graph region is the y-axis region. If the system does not detect my peaks in the projection values, the system concludes that the graph image is not a rectangular graph. Each rectangular graph has at least two peaks, one peak corresponding to an x-axis line and another peak corresponding to a y-axis line. For example, while the image in FIG. 1C has a left y-axis and bottom x-axis, another bar graph may have a right y-axis and a bottom x-axis. This processing confirms that the graph is bound by axes and is therefore a rectangular graph.

According to the projection values, the binary image data is divided into three separate regions, as depicted in FIG. 1C, an x-axis region, y-axis region and the main graph region. Then, the axes regions are passed through a smoothing filter that performs horizontal and vertical smoothing on the x and y axes regions of the graph image, respectively, to determine regions of the text values included on the x and y axes. One of skill in the art will appreciate that the smoothing filter referred to herein may refer to any generic process for clustering a location of data depending on the neighboring pixel data.

The text values included on both the x and y axes are processed according to a smoothing filter, which merges the position of values that are within a pre-specified proximity to one another and maintains-the distance among values that are further away from one another. The result of the smoothing process is to create a logical box, i.e., a bounding box, around each of the text values included on the x and y axes. The bounding box provides information about the location of these text values in the original image. The bounding box information is used when the graph is reduced to ensure that the clarity of the values will be maintained during the reduction. For example, a horizontal smoothing filter set with a threshold value of 2 changes from zero to one each of the bits between locations when the number of bits between the locations is less than two. This filter would therefore change the following sequence of 1100110000101 to 1111110000111. This processing segments, i.e., separates, each of the text values included on the x and y axes. Note that this segmentation includes decreasing unnecessary spaces within a text value and maximizing space among adjacent text values. Thus, on the x and y axes, each individual value is logically enclosed by a rectangular box, i.e., a text value bounding box, as depicted in FIG. 1C. The system stores the location values reflected by the leftmost and rightmost x values and the top and bottom y values.

The axes data indicating a location for each of the text values included on the x and y axes, i.e., the location information, is stored in a database as metadata (328). The term metadata reflects information about image data. Specifically, the metadata file includes location and positioning information of the text values included on the x and y axes of a graph image. The metadata file includes information reflecting a graph type, determined according to the location of the origin of the graph. The metadata may be stored, for example, on a disk of the server running the system. When the current graph image is accessed by a different device and requires reduction to a different size, the metadata may be retrieved and used to determine the structure of the original image. Thus, when an image is transcoded for the first time, the analyzed information is stored as metadata. When the same image is subsequently transcoded for display on a different size device, the stored metadata is retrieved and processed as described below. More specifically, the decoded graph image is input into a metadata reader which reads the metadata corresponding to the graph image and completes the processing required to reduce the image according to the metadata.

Because the invention reduces an image according to both a size and capability of a display device, the system receives device profile data and considers it in developing an appropriate reduced graph image (334). The device profile data indicates, for example, the width, height, and color depth of the display device. As described above, the network browser of a device accessing the system provides the device profile data to the system when requesting that an original graph image be reduced by the system.

Next, the axes regions of the graph image are converted into the number of colors supported by the device (340). A color histogram, i.e., a frequency distribution of colors, is created to determine the colors included in the axes regions of the original graph image. The 8-bit image of the original graph image will have 2⁸=256 colors. The histogram reflects a number of pixels in the 8-bit image that have a particular value, i.e., are of a particular color. Each of these colors is referred to as a “bin.” Thus, an 8-bit image includes 256 bins and each bin value represents the total number of pixels included in the image that have that value. More specifically, bin (k)=n, where n is the number of pixels of color value k.

In general, the background area of a graph is in one color, the axis values and axes are in another color, and the plots included in the main graph area are in different colors. Consistent with such color scheme, when creating a color conversion histogram for a device that only has black and white color display capabilities, the background area, which is generally significantly larger than the graph image itself, is mapped to “white.” The axes values and the axes are mapped to “black.” Multiple colored images included in the graph region are mapped to a variety of graph values, depending on the display capabilities of the device. For example, if there are 4 distinct colored graph plots in an original graph image, when the image is converted for display on a binary display device, all the plots will be displayed as “black.” If the axes region includes five significant colors and the display device only supports a 2-bit color display, i.e., four colors, then the 256 bins are divided into four ranges, e.g., 0-63, 64-127, 128-191, 192-255. Each color is mapped into one of the four colors supported by the output device according to the range in which the color falls.

Then, the number of axis values that can be included in the reduced graph image is determined by dividing the amount of space required for an axis value by the amount of space available on the display device (348). This determination considers that while an axis of an original image may have “n” values, a reduced image may only be able to clearly display “k” of the “n” values (k<=n) while maintaining the clarity and readability of all of the displayed “k” values. The “k” axis values are determined as follows: Let the axis values included in the original graph correspond to (0, 1, . . . n−1). Of these original axis values, the reduced graph image will display at least value “0” and value “n−1.” The reduced graph image will display a number, “k,” of the other axis values according to the size of the reduced image. To choose the “k” values that will be displayed, a tree is formed as follows: for a horizontal axis, the leftmost axis value is set to “0” and the rightmost axis value is set to “n−1.” The mid-value is set to the integer corresponding to “(0+(n−1))/2.” The value of each of the other axis points is determined according to the same formula, applied recursively. Therefore, the value of the axis point that lies between “0” and “(0+n−1)/2” is “(n−1)/4,” and the value of the axis point that lies between “(0+n−1)/2” and “n−1” is “3(n−1)/4.”

For example, the values of a horizontal axis would be numbered as follows:

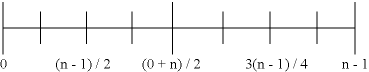

As an example, consider that “n”=6, i.e., the axis includes values 0, 1, 2, 3, 4, and 5. The corresponding tree would be the following:

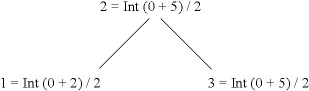

Consider an example where “n”=9, i.e., the axis includes values 0, 1, 2, 3, 4, 5, 6, 7, and 8. The corresponding tree would be the following:

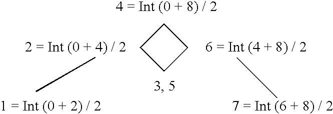

The axis values that will be displayed in the reduced image are selected in a top-down manner from the decision tree of the x-axis and y-axis values. For a graph having its origin at the bottom left comer, the top and bottom “y” values, and the first and last “x” values are assigned the highest priority and will be included in the reduced image. The priority of the other values in the tree is determined from top to bottom and left to right. Thus, for the above tree, the values would be selected in the following manner: 4, 2, 6, 1, 7, 3, 5. The values having the lowest priorities will therefore not be displayed on display devices that have small display windows. For example, consider an image that includes a graph of size 400×200 (width×length), where the graph region is 380×180, the y-axis region is 20×180 and the x-axis region is 380×20. Suppose there are five text values included on the x-axis and each text value has a height of 20 and a width of 30. Suppose that the size of the display device requesting a reduction of the graph image is 100×50. The text values included in the x-axis region, which are located at the bottom of the graph image, require a height of 20 and the text values in the y-axis region, which are located on the left side of the graph image, require a width of 20. Thus, the resulting axes region will be 20×20 and the resulting main graph image will be 80×20, determined as follows: the amount of space required to proportionately display the axes regions is subtracted from the size of the total graph image, and the remaining size corresponds to the proportionate size of the reduced main graph region of the graph image. Thus, the 100×50 graph will be divided as follows: graph region width: 100-20=80; graph region height: 50−30=20.

The main graph region of the graph image is then reduced according to a conventional image reduction technique that preserves the structure of the graph image (356). The reduction of the main graph region is therefore performed separately from reduction of the axes region of the graph image, and according to a different reduction technique.

Then, the reduced graph of 356 and the adaptive axes formed in 348 are “stitched” to form the complete reduced graph image. Stitching refers to combining image values to create a final image and includes the following operations: (1) creating an empty buffer reflecting the size of the reduced image; (2) inserting the reduced graph of 356 into the newly created buffer; and (3) inserting the selected axis values relative to their position in the original image. The relative positions of the each of the axis values corresponds to the bounding box positions stored as metadata.

When stitching the reduced main graph region and the axes regions, the width and height of the display device and the relative size of each of the axes values (e.g., the number of characters included in each axis value), are considered. Therefore, the larger the display size, the greater the number of axis values that can be displayed. Continuing with the previous example, each x-axis text value in the original image is 30×20, but the width of the output image is only 100. Therefore, the number of values that can be stitched in the reduced graph image is 100/30=3. The same computation is performed for the text values on the y-axis. Then, the appropriate number of values are selected from the trees created above.

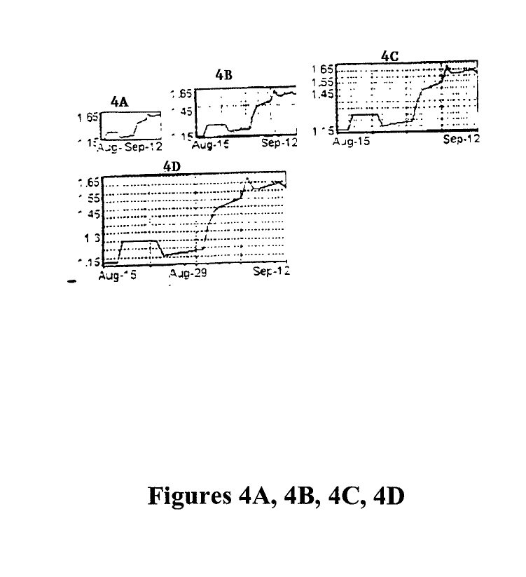

FIGS. 4A-4D depict the output of the stitching processing relative to reducing the graph image of FIG. 1A to various sizes. The original image was 400×200. It has been reduced to four different sizes, 80×40, 120×60, 160×80, and 200×100, from smallest to largest. The smallest image, FIG. 4A, includes only part of the “0” axis value and includes all of the last axis value. FIGS. 4B and 4C include both the first and last axis values completely, i.e., the “0” and “n−1” values. FIG. 4D is larger than the other images and includes the first, last, and middle axis values, i.e., “0”, “n−1”, and “(0+n−1)/2” values.

Once the graph has been stitched, the raw image is encoded to a specific image format that can be supported by a particular display device (362). The image formats may include, for example, a JPEG, GIF, or BMP format.

Although this invention has been described relative to a particular embodiment, one of skill in the art will appreciate that this description is merely exemplary and the system and method of this invention may include additional or different components. This description is therefore limited only by the appended claims and the full scope of their equivalents.

What is claimed is:

1. A method for reducing a rectangular graph image, comprising:
identifying a main graph region and axes regions of an original graph image;
correlating text values included in the axes regions to relative axes locations of the main graph image;
prioritizing the text values;
determining a number of the text values that can be displayed in a reduced-size graph image on a display device of a particular size;
selecting the text values that will be displayed according to the prioritization of the text values;
reducing the main graph region according to a first reduction process to create a reduced main graph region;
reducing the axes regions according to a second reduction process to create reduced axes regions; and
stitching together the reduced main graph region and the reduced axes regions according to the created correlation.

2. The method of claim 1, further including converting the original graph image into a number of colors supported by the display device.

3. The method of claim 2, further including creating a frequency distribution of the colors included in the original graph image

4. A method for reducing a rectangular graph image, comprising:
receiving an original rectangular graph image;
determining a structure of the original rectangular graph image and dividing the original rectangular graph image into a main graph region and axes regions;
reducing the axes regions of the original rectangular graph image according to the structure of the original rectangular graph image and a characteristic of a display device;
receiving a reduced main graph region; and
stitching together the reduced main graph region and the reduced axes regions to create a reduced rectangular graph image.

5. The method of claim 4, wherein the stitching includes selecting a text value having a highest priority.

6. The method of claim 4, further comprising decoding the original rectangular graph image.

7. The method of claim 4, further comprising converting the original graph image into a number of colors supported by the display device.

8. The method of claim 4, further comprising coding the reduced rectangular graph image into a display format such that the reduced rectangular graph image can be displayed on a display device.

9. The method of claim 4, wherein the receiving includes receiving the original rectangular graph image over a network.

10. The method of claim 4, wherein the determining includes determining location information reflecting a location of a relative position of a text value included in the axes regions.

11. The method of claim 10, further comprising storing the location information.

12. The method of claim 11, further comprising retrieving the location information.

13. The method of claim 4, wherein the reducing includes reducing the text values included in the axes regions such that the readability and clarity of the text values is maintained.

14. The method of claim 4, further comprising smoothing of the axes regions to identify a position of values included in the axes regions.

15. A method for reducing a rectangular graph image for display on a limited-capability display device, comprising:
receiving an original rectangular graph image;
determining the structure of the original rectangular graph image and dividing the original rectangular graph image into a main graph region and axes regions;
providing information reflecting display characteristics of the display device;
reducing the axes regions of the original rectangular graph image according to a first reduction process;
receiving a reduced main graph region that has been reduced according to a second reduction process; and
stitching together a reduced main graph region and the reduced axes regions to create a reduced rectangular graph image.

16. The method of claim 15, further including coding the reduced graph image to a format that is compatible with the display device.

17. The method of claim 15, wherein reducing the axes regions includes reducing the axes regions according to parameters of the display device and a location of text values included in the axes regions.

18. A system to reduce a rectangular graph image, comprising:
an adaptive graph image transcoder that receives an original rectangular graph image, decodes the original rectangular graph image, receives information reflecting a size and a color depth of the display device, and reduces axes regions of the original rectangular graph image according to one or more device parameters of the display device and a location of values included on the axes of the original rectangular graph image, and
stitches together the reduced axes regions and a reduced main graph region; and
a graph reduction device that reduces a main graph region of the original rectangular graph image according to the size of the display device.

19. A system to reduce a rectangular graph image for display on a display device, comprising:
an adaptive graph image transcoder that receives an original rectangular graph image including a main graph region and axes regions, receives one or more device parameters of the display device and a location of values included on axes of the original rectangular graph image, and reduces the axes regions of the original rectangular graph image according to a first reduction process that reduces the axes regions according to the parameters of the display device and the location of values included on the axes of the original rectangular graph image to create reduced axes regions.

20. The system of claim 19, further including reducing the main graph region according to a second reduction process to create a reduced main graph region, and
stitching together the reduced axes regions and the reduced main graph region to create a reduced graph image.

21. The system of claim 20, further including an image coder that codes the reduced graph image into a format that is compatible with the display device.

22. The system of claim 19, further comprising an image decoder that decodes the original rectangular graph image into a raw rectangular graph image.

23. The system of claim 19, further including a display device that includes a browser that displays the original rectangular graph image and the reduced rectangular graph image.

24. A computer-readable medium comprising instructions for reducing a rectangular graph image, the instructions comprising:
identifying a main graph region and axes regions of an original graph image;
correlating text values included in the axes regions to relative axes locations of the main graph image;
prioritizing the text values;
determining a number of the text values that can be displayed in a reduced-size graph image on a display device of a particular size;
selecting the text values that will be displayed according to the prioritization of the text values;
reducing the main graph region according to a first reduction process to create a reduced main graph region;
reducing the axes regions according to a second reduction process to create reduced axes regions; and
stitching together the reduced main graph region and the reduced axes regions according to the created correlation.

25. A computer-readable medium comprising instructions for reducing a rectangular graph image, the instructions comprising:
receiving an original rectangular graph image;
determining a structure of the original rectangular graph image and dividing the original rectangular graph image into a main graph region and axes regions;
reducing the axes regions of the original rectangular graph image according to the structure of the original rectangular graph image and a characteristic of a display device;
receiving a reduced main graph region; and
stitching together the reduced main graph region and the reduced axes regions to create a reduced rectangular graph image.
